(19) United States
(12) Patent Application Publication
(10) Pub. No.: US 2018/0368214 A1
(43) Pub. Date: Dec. 20, 2018

(54) An induction hob device and a method for operating an induction hob device

(71) Applicant: BSH Hausgeräte GmbH, Munich (DE)

(72) Inventors: Jesus Acero Acero, Zaragoza (ES); Claudio Carretero Chamarro, Zaragoza (ES); Sergio Llorente Gil, Zaragoza (ES); Ignacio Lope Moratilla, Zaragoza (ES); Daniel Palacios Tomas, Zaragoza (ES)

(21) Appl. No.: 16/061,361

(22) PCT Filed: Nov. 24, 2016
(86) PCT No.: PCT/IB2016/057106

§ 371 Date: Jun. 12, 2018

(30) Foreign Application Priority Data
Dec. 23, 2015 (ES) P201531903

(51) Int. Cl. H05B 6/06; H05B 6/44

(52) U.S. Cl. CPC H05B 6/062; H05B 6/44

(57) ABSTRACT

An induction hob device comprising at least one cooktop at least one first coil and at least one second coil which are displaced relative to each other at least in a direction perpendicular to the cooktop and with a control unit.

In order to improve an efficiency, it is proposed that the control unit is provided to at least temporarily operate the first coil and the second coil simultaneously.

The invention relates to an induction hob device according to the preamble of claim 1 and a method for operating an induction hob device according to the preamble of claim 14.

It is known to use induction hobs comprising at least one cooktop and several inductors which are located below the cooktop. Thereby, the inductors are located in-plane and distanced from each other.

Further, the document EP 1 858 300 A1 discloses an induction hob comprising a cooktop and several one-layer inductors which are displaced relative to each other at least in a direction perpendicular to the cooktop, wherein the inductors are operated alternately.

The objective of the invention is, in particular, to provide a generic device with improved characteristics regarding an efficiency. The objective is achieved, according to the invention, by the characterizing features of claims 1 and 14, while advantageous implementations and further developments of the invention can be obtained by the dependent claims.

The invention relates to an induction hob device comprising at least one cooktop, at least one first coil and at least one second coil which are displaced relative to each other at least in a direction perpendicular to the cooktop and in particular at least when seen in a direction parallel to a main extension plane of the cooktop, and with a control unit.

It is proposed that the control unit is provided to at least temporarily operate the first coil and the second coil simultaneously. “Provided” is to be understood in particular as specifically programmed, designed and/or equipped. By an object being provided for a certain function, it is in particular to be understood that the object fulfills and/or implements this certain function in at least one application state and/or operating state. A “main extension plane” of an object, is to be understood, in particular, as a plane which is parallel to a largest side and/or face of a smallest, in particular imagined, in particular geometric, cuboid, which encloses the object just completely and preferably intersects a center, in particular a geometric center, of the cuboid.

An “induction hob device” is to be understood, in particular, at least as a part, in particular a subassembly, of an induction hob. Moreover, the induction hob device may, in particular, also comprise the entire induction hob. Preferably, the induction hob device comprises a plurality of coils and/or inductors, in particular at least four, preferably at least six, advantageously at least twelve, more advantageously at least twenty-four and most advantageously at least forty-eight coils and/or inductors. Hence, the induction hob device preferably is formed as a matrix-hob device and/or a flexible hob device.

In this context, a “coil” is to be understood, in particular, as an inductive element, which preferably is formed by at least one wire, in particular heating wire, and which advantageously is part of an inductor. The coil, in particular, comprises at least one winding and preferably several windings like at least two, at least five, at least ten and/or at least fifteen windings, in particular located in one layer and/or preferably in several layers. Advantageously, the coil is provided to generate an alternating electromagnetic field, which is converted into heat in a bottom of a cooking utensil by means of eddy currents and/or magnetization and demagnetization effects. Particularly advantageously, the first coil and the second coil comprise a same diameter and are preferably at least substantially identical. In this context, a “diameter” of an object is supposed to refer, in particular, to a diameter of a smallest, in particular imagined, circuit, which encloses the object just completely. The term “at least substantially identical” is to be understood, in particular, as identical apart from manufacturing tolerances and/or within the limits of standardized tolerances and/or within the limits of manufacturing possibilities.

Moreover, a “control unit”, in particular, is to be understood to mean an electrical and/or electronical unit, which is provided to control and/or regulate an operation of the induction hob and/or at least of a subassembly of the induction hob. For this purpose, the control unit preferably comprises a processor unit, a memory unit and/or an operating program which is advantageously stored in the memory unit and preferably executed by the processor unit. In addition, the induction hob device may, in particular, comprise at least one power supply unit, which is in particular provided to supply at least one of the coils with energy, and/or at least one retainer unit, which in particular comprises at least one retainer element which is, in particular, provided to retain and/or support at least one of the coils. In particular, the retainer element can be formed as an arbitrary retainer element like a retainer plate, in particular a printed circuit board and/or a printed circuit board-substrate, and/or a, in particular specifically constructed, holder. By the implementation according to the invention, an induction hob device can be obtained, in particular having improved characteristics regarding an efficiency, in particular a power efficiency, an installation space efficiency, a component efficiency and/or a cost efficiency. Additionally, a flexibility can be advantageously increased. Thereby, in particular an improved distribution and/or arrangement of the coils may be obtained, which, in particular, leads to a particularly uniform power distribution by which an advantageous thermal distribution in the bottom of a cooking utensil may be achieved. In addition, in particular an improved coverage resolution, in particular with respect to a cooking utensil placed on the cooktop, may be obtained by which, in particular, a flexibility can be further increased.

Preferably, the first coil and the second coil are substantially displaced relative to each other at least in a direction parallel to the cooktop and/or at least when seen in a direction perpendicular to the main extension plane of the cooktop. By the expression that an object is “substantially displaced” with respect to a further object at least in a direction parallel to the cooktop, it is to be understood, in particular, that at most 85%, advantageously at most 80% and more advantageously at most 75% of all lines, which emanate from the object and are perpendicular to the main extension plane of the cooktop, intersect the further object. Preferably, the second coil is arranged with respect to the first coil in such a way that a center, in particular a geometric center, of the second coil is distanced from an outer border of the first coil at least when seen in the direction perpendicular to the main extension plane of the cooktop. By that, in particular a distribution and/or an arrangement of the coils can be optimized.

Further, it is proposed that the first coil and the second coil at least partly overlap at least in a direction perpendicular to the cooktop and/or at least when seen in the direction perpendicular to the main extension plane of the cooktop. Particularly advantageously, an overlapping area between the first coil and the second coil amounts to at least 5%, preferably at least 10% and more preferably at least 15%, and at most 45%, preferably at most 40% and more preferably at most 35%, of a total surface area of the first coil or the second coil at least when seen in the direction perpendicular to the main extension plane of the cooktop. By that, in particular a distance between centers of the coils can be reduced and/or a diameter of the inductor can be increased, in particular by a factor 1.77, while a distance between the centers can be kept constant.

Moreover, it is proposed that the first coil and the second coil are located directly adjacent relative to each other. By the expression that two coils are “directly adjacent”, it is to be understood, in particular, that no other coil is located between the two coils. As a result, in particular, a particularly compact induction hob device may be obtained.

In accordance with the invention, it is proposed that the first coil and the second coil are electrically connected, in particular in parallel and/or in series and preferably by means of an electrical wire and/or a via, in particular in case of using printed circuit board retainer elements. By this, in particular a control algorithm may be advantageously simplified.

In one preferred embodiment of the invention, it is proposed that the induction hob device comprises at least one third coil which is displaced relative to the first coil and the second coil at least in a direction perpendicular to the cooktop and in particular at least when seen in the direction parallel to the main extension plane of the cooktop, wherein the control unit is provided to at least temporarily operate the third coil simultaneously with the first coil and the second coil. Advantageously, the third coil and the first coil and/or the third coil and the second coil comprise a same diameter and are preferably at least substantially identical. Particularly advantageously, the third coil is located directly adjacent to the first coil and/or the second coil. As a result, in particular, a coverage resolution may be further increased, by which a particularly uniform power distribution may be achieved.

Further, it is proposed that the third coil is substantially displaced relative to the first coil and/or the second coil at least in a direction parallel to the cooktop and/or at least when seen in the direction perpendicular to the main extension plane of the cooktop. Preferably, the third coil is arranged with respect to the first coil and the second coil in such a way that a center, in particular a geometric center, of the third coil is distanced from an outer border of the first coil and the second coil at least when seen in the direction perpendicular to the main extension plane of the cooktop. Hereby, in particular a distribution and/or an arrangement of the coils may be further optimized.

A particularly compact induction hob device may in particular be obtained, if the third coil and the first coil and/or the third coil and the second coil at least partly overlap at least in a direction perpendicular to the cooktop and/or at least when seen in the direction perpendicular to the main extension plane of the cooktop. Advantageously, an overlapping area between the third coil and the first coil amounts to at least 5%, preferably at least 10% and more preferably at least 15%, and at most 45%, preferably at most 40% and more preferably at most 35%, of a total surface area of the third coil or the first coil at least when seen in the direction perpendicular to the main extension plane of the cooktop. In addition, preferably an overlapping area between the third coil and the second coil amounts to at least 5%, preferably at least 10% and more preferably at least 15%, and at most 45%, preferably at most 40% and more preferably at most 35%, of a total surface area of the third coil or the second coil at least when seen in the direction perpendicular to the main extension plane of the cooktop.

Additionally, it is proposed that the third coil and the first coil and/or the third coil and the second coil are electrically connected, in particular in parallel and/or in series and preferably by means of an electrical wire and/or a via, in particular in case of using printed circuit board retainer elements, by which in particular a control algorithm may be advantageously simplified. Thereby, the first coil, the second coil and the third coil are advantageously electrically connected, in particular in parallel and/or in series and preferably by means of an electrical wire and/or a via, in particular in case of using printed circuit board retainer elements.

In one embodiment, it is proposed that the first coil and the second coil at least partly, preferably at least largely and more preferably completely, form an, in particular exactly one, inductor. Particularly advantageously, the first coil, the second coil and the third coil at least partly, preferably at least largely and more preferably completely, form an, in particular exactly one, inductor. The term “at least largely” is to be understood, in particular, as at least 55%, advantageously at least 65%, preferably at least 75%, more preferably at least 85% and particularly advantageously at least 95%. By that, in particular a simple construction may be obtained.

A particularly uniform heat distribution and/or thermal distribution may, in particular, be obtained, if the induction hob device comprises at least one further inductor which is at least substantially identical to the inductor, wherein the inductors comprise an at least substantially equal effective distance to the cooktop. In this context, an “effective distance to the cooktop”, is to be understood, in particular, as a distance which corresponds to an arithmetic mean of distances, which is in particular obtained by adding up the distances of all coils of one inductor to the cooktop and dividing the result by the number of coils. Moreover, by an “at least substantially equal effective distance”, it is to be understood, in particular, that an effective distance of an inductor differs from an effective distance of a further inductor by at most 10%, preferably at most 7.5% and more preferably at most 5%.

Moreover, it is proposed that the inductors interleave each other, in particular at least when seen in the direction perpendicular to the main extension plane of the cooktop. By the expression that “an object interleaves a further object at least when seen in the direction perpendicular to a main extension plane of the cooktop”, it is to be understood, in particular, that at least one line exists which is perpendicular to the main extension plane of the cooktop and intersects the object and the further object, in particular at least when seen in the direction perpendicular to the main extension plane of the cooktop. As a result, a particularly compact and/or flexible induction hob device can be obtained.

Further, the invention relates to a method for operating an induction hob device, wherein the induction hob device comprises at least one cooktop, at least one first coil and at least one second coil which are displaced relative to each other at least in a direction perpendicular to the cooktop and in particular at least when seen in a direction parallel to a main extension plane of the cooktop.

It is proposed that the first coil and the second coil are at least temporarily operated simultaneously. By that, in particular, an efficiency, in particular a power efficiency, an installation space efficiency, a component efficiency and/or a cost efficiency, and/or a flexibility can be advantageously increased. Moreover, in particular an improved distribution and/or arrangement of the coils may be obtained, which, in particular, leads to a particularly uniform power distribution by which an advantageous thermal distribution in the bottom of a cooking utensil may be achieved.

The induction hob device is herein not limited to the application and to the implementation described above. In particular, for the purpose of fulfilling a functionality herein described, the induction hob device can comprise a number of respective elements, structural components and units that differ from the number mentioned herein.

Further advantages of the invention may be derived from the description of the figures below. The figures show four exemplary embodiments of the invention. The figures, the description and the claims contain numerous features in combination. The features may also be considered individually, and may be combined into useful further combinations.

It is shown in:

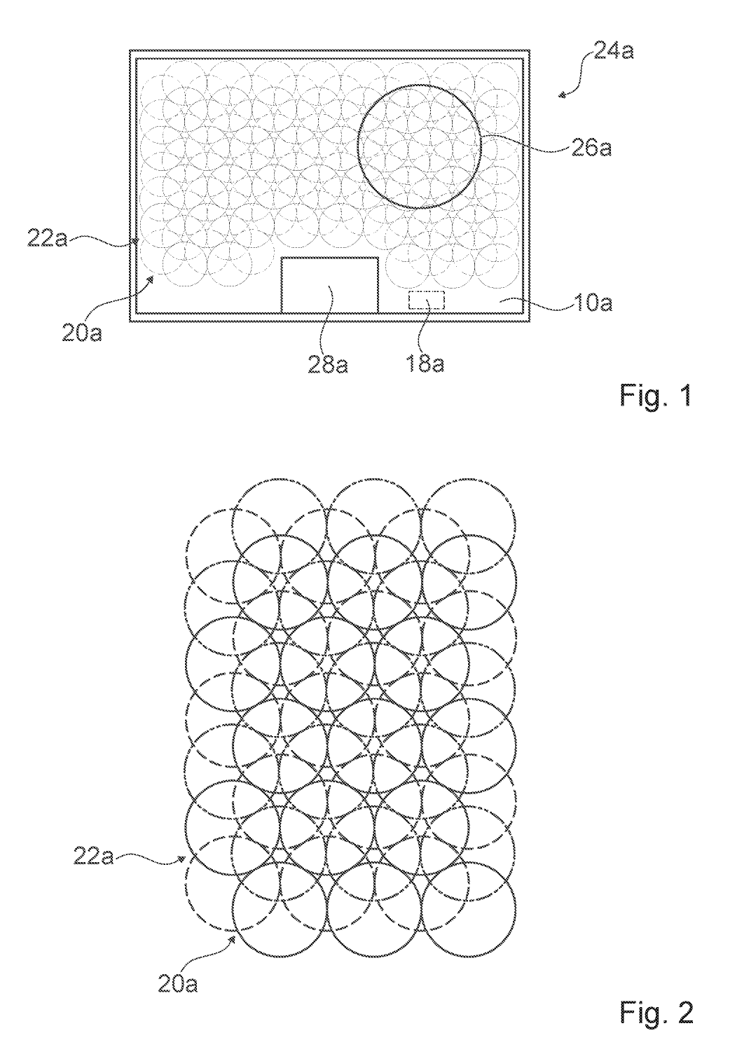

FIG. 1 a simplified schematic top view of an induction hob comprising an induction hob device having a cooktop and several inductors,

FIG. 2 an enlarged view of the inductors,

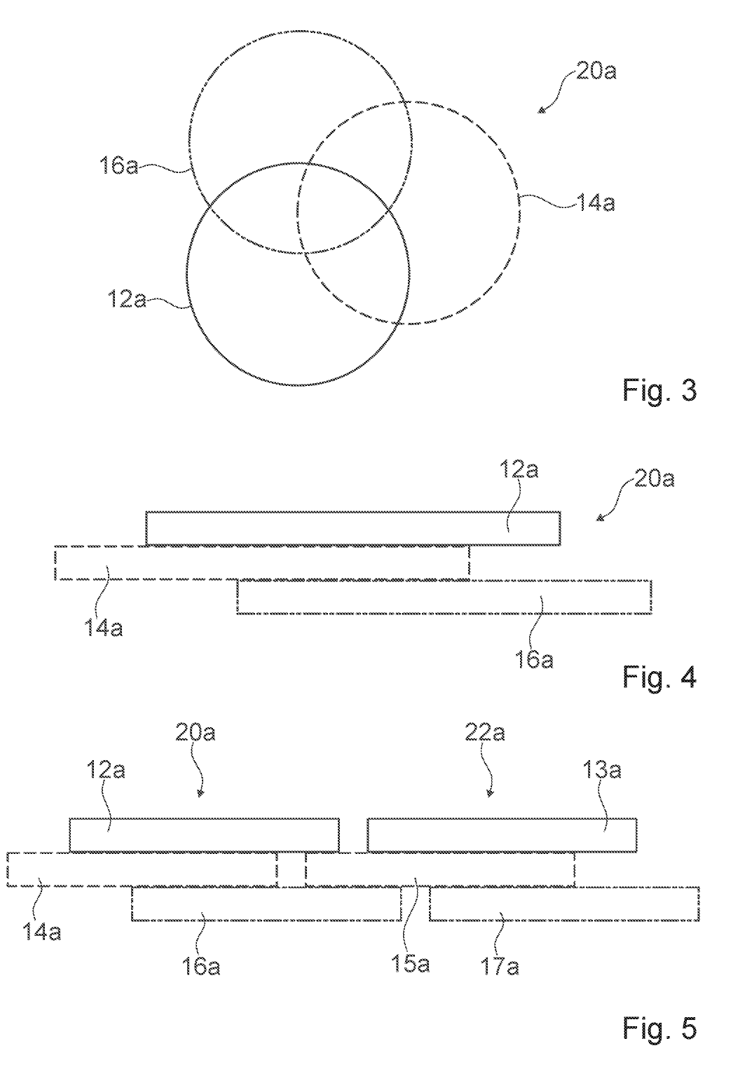

FIG. 3 a simplified schematic top view of one inductor of the inductors,

FIG. 4 a simplified schematic side view of the inductor,

FIG. 5 a simplified schematic side view of the inductor and an at least substantially identical further inductor of the inductors,

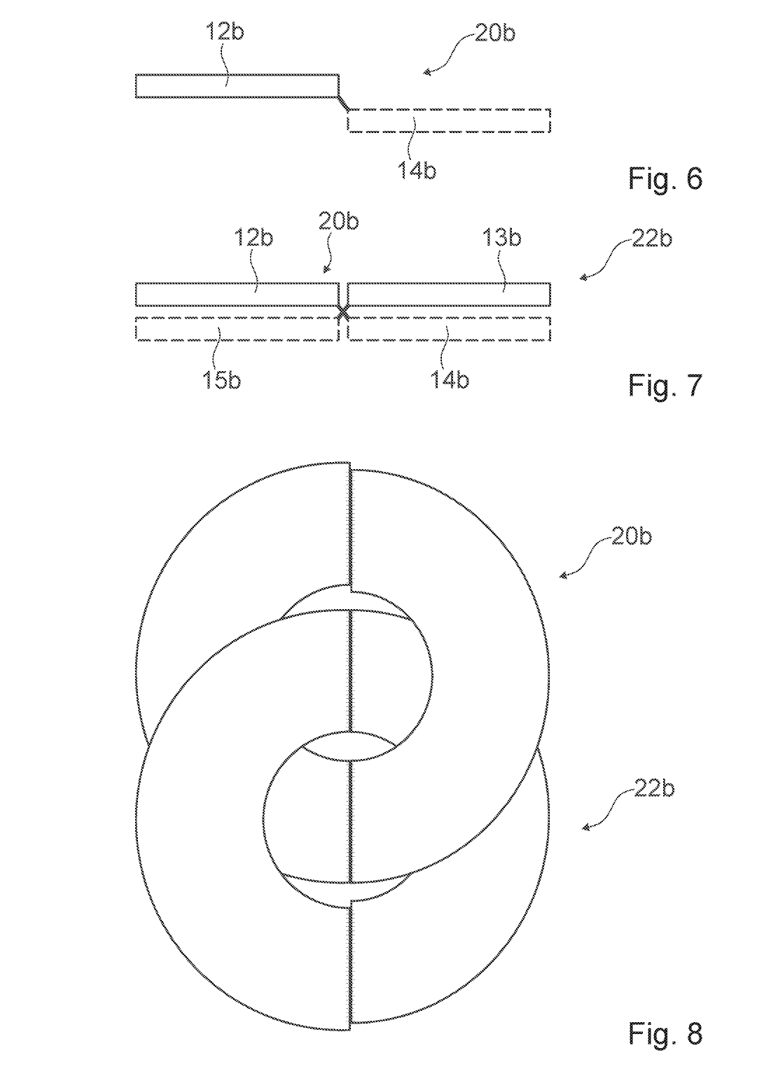

FIG. 6 a simplified schematic side view of an inductor of a further induction hob device,

FIG. 7 a simplified schematic side view of the inductor of FIG. 6 and an at least substantially identical further inductor,

FIG. 8 a simplified schematic top view of the inductors of FIG. 7,

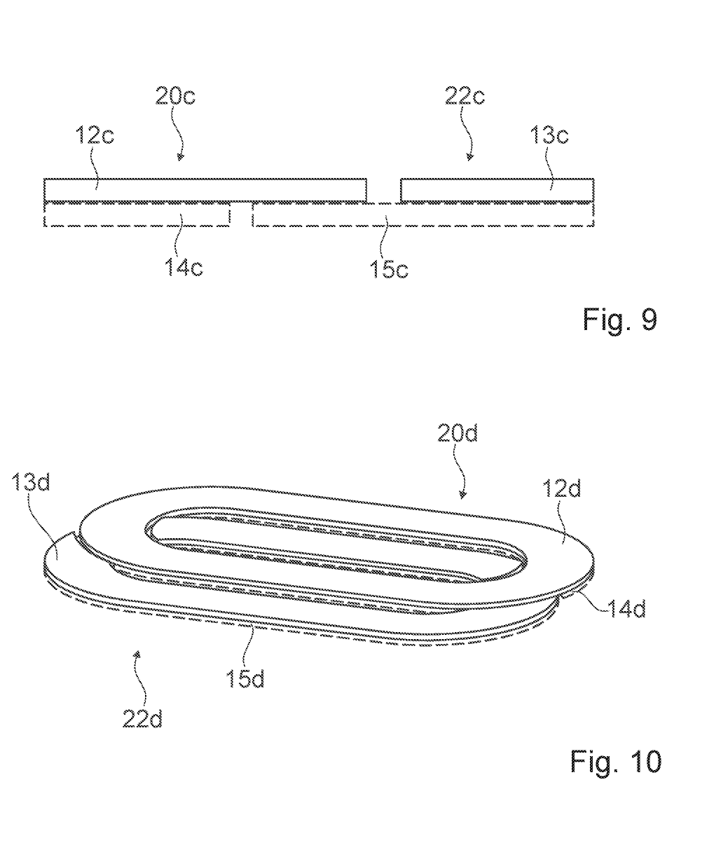

FIG. 9 a simplified schematic side view of an inductor of a further induction hob device and

FIG. 10 a simplified perspective view of an inductor of a further induction hob device.

FIG. 1 shows a top view of an exemplary induction hob 24a. In the present case, the induction hob 24a is formed as a matrix-hob and/or a flexible hob. The induction hob 24a comprises an induction hob device. The induction hob device comprises a cooktop 10a. The cooktop 10a is adjustable and comprises flexible and/or changeable heating zones. The cooktop 10a and/or heating zones are provided to heat at least one cooking utensil 26a.

The induction hob device further comprises an operating interface 28a. The operating interface 28a is provided for controlling an operation of the induction hob 24a and/or the induction hob device, in particular by entering and/or choosing at least one parameter like a heating power, a heating density, a heating stage and/or a heating zone.

Moreover, the induction hob device comprises a control unit 18a. The control unit 18a comprises a processor unit, a memory unit and an operating program which is stored in the memory unit and executed by the processor unit. The control unit 18a is provided for controlling a cooking process.

The induction hob device further comprises at least one inductor 20a, 22a. In the present case, the induction hob device comprises a plurality of inductors 20a, 22a, here in particular between 12 and 48 inductors 20a, 22a, wherein for simplicity, in particular, in FIGS. 1 and 2 merely two of the inductors 20a, 22a are provided with reference numbers. The inductors 20a, 22a are located below the cooktop 10a. The inductors 20a, 22a correspond to heating units. The inductors 20a, 22a are at least substantially identical. The inductors 20a, 22a are arranged in such a way that the inductors 20a, 22a comprise an equal effective distance to the cooktop 10a. The inductors 20a, 22a are provided to create the, in particular flexible, heating zones. The inductors 20a, 22a are provided for generating an alternating electromagnetic field, which is converted into heat in a bottom of the cooking utensil 26a by means of eddy currents and/or magnetization and demagnetization effects. As an alternative, it is conceivable that an induction hob device comprises two, four and/or six, in particular non-flexible, heating zones and/or two, four and/or six inductors, wherein each inductor is assigned to one of the heating zones.

In the following with respect to FIGS. 3 and 4 merely one inductor 20a of the inductors 20a, 22a is described in more detail. Thereby, the following description can also be applied to the further inductors 22a of the inductors 20a, 22a, in particular due to the at least substantially identical construction of the inductors 20a, 22a.

The inductor 20a comprises a first coil 12a. The first coil 12a is formed as a spiral coil. The first coil 12a is at least substantially circular at least when seen in a direction perpendicular to a main extension plane of the cooktop 10a. The first coil 12a comprises fifteen windings in one layer. The first coil 12a is located directly adjacent to the cooktop 10a. As an alternative, it is conceivable that a first coil comprises an arbitrary other number of windings and/or layers. Thereby, a first coil might be formed as a solenoid and/or an elliptic coil. Moreover, the inductor 20a comprises a second coil 14a. The second coil 14a is formed as a spiral coil. The second coil 14a is at least substantially circular at least when seen in the direction perpendicular to the main extension plane of the cooktop 10a. The second coil 14a comprises fifteen windings in one layer. The second coil 14a is at least substantially identical to the first coil 12a. The second coil 14a is displaced relative to the first coil 12a at least in a direction perpendicular to the cooktop 10a. The second coil 14a is located below the first coil 12a in particular with respect to the cooktop 10a. Thereby, the second coil 14a is located directly adjacent to the first coil 12a, in particular at least when seen in the direction perpendicular and parallel to the main extension plane of the cooktop 10a.

Moreover, the second coil 14a is substantially displaced relative to the first coil 12a at least in a direction parallel to the cooktop 10a. The second coil 14a is thereby arranged with respect to the first coil 12a in such a way that a geometric center of the second coil 14a is distanced from an outer border of the first coil 12a at least when seen in the direction perpendicular to the main extension plane of the cooktop 10a. Furthermore, the first coil 12a and the second coil 14a at least partly overlap at least when seen in the direction perpendicular to the main extension plane of the cooktop 10a. In the present case, an overlapping area between the first coil 12a and the second coil 14a amounts to about 30% of a total surface area of the first coil 12a or the second coil 14a at least when seen in the direction perpendicular to the main extension plane of the cooktop 10a.

In the present case, the first coil 12a and the second coil 14a are additionally electrically connected. Thereby, the first coil 12a and the second coil 14a are connected in series. As an alternative, it is conceivable that a first coil and a second coil are connected in parallel or are not connected. Thereby, it is also conceivable that a second coil is part of another inductor. Moreover, it is conceivable that a second coil comprises an arbitrary other number of windings and/or layers. Furthermore, a second coil might be formed as a solenoid and/or an elliptic coil. Additionally, it is conceivable that a second coil is flipped and/or mirrored relative to a first coil, in particular with respect to a plane which is parallel to a main extension plane of a cooktop.

Moreover, the inductor 20a comprises a third coil 16a. The third coil 16a is formed as a spiral coil. The third coil 16a is at least substantially circular at least when seen in the direction perpendicular to the main extension plane of the cooktop 10a. The third coil 16a comprises fifteen windings in one layer. The third coil 16a is at least substantially identical to the first coil 12a and the second coil 14a. The third coil 16a is displaced relative to the first coil 12a at least in a direction perpendicular to the cooktop 10a. In addition, the third coil 16a is displaced relative to the second coil 14a at least in a direction perpendicular to the cooktop 10a. The third coil 16a is located below the first coil 12a in particular with respect to the cooktop 10a. Moreover, the third coil 16a is located below the second coil 14a in particular with respect to the cooktop 10a. Thereby, the third coil 16a is located directly adjacent to the second coil 14a, in particular at least when seen in the direction perpendicular and parallel to the main extension plane of the cooktop 10a.

Moreover, the third coil 16a is substantially displaced relative to the first coil 12a at least in a direction parallel to the cooktop 10a. The third coil 16a is thereby arranged with respect to the first coil 12a in such a way that a geometric center of the third coil 16a is distanced from an outer border of the first coil 12a at least when seen in the direction perpendicular to the main extension plane of the cooktop 10a. In addition, the third coil 16a is substantially displaced relative to the second coil 14a at least in a direction parallel to the cooktop 10a. The third coil 16a is thereby arranged with respect to the second coil 14a in such a way that a geometric center of the third coil 16a is distanced from an outer border of the second coil 14a at least when seen in the direction perpendicular to the main extension plane of the cooktop 10a.

Furthermore, the first coil 12a and the third coil 16a at least partly overlap at least when seen in the direction perpendicular to the main extension plane of the cooktop 10a. In the present case, an overlapping area between the first coil 12a and the third coil 16a amounts to about 30% of a total surface area of the first coil 12a or the third coil 16a at least when seen in the direction perpendicular to the main extension plane of the cooktop 10a. In addition, the second coil 14a and the third coil 16a at least partly overlap at least when seen in the direction perpendicular to the main extension plane of the cooktop 10a. In the present case, an overlapping area between the second coil 14a and the third coil 16a amounts to about 30% of a total surface area of the second coil 14a or the third coil 16a at least when seen in the direction perpendicular to the main extension plane of the cooktop 10a.

Besides, the first coil 12a, the second coil 14a and the third coil 16a are electrically connected. Thereby, the first coil 12a, the second coil 14a and the third coil 16a are connected in series and in particular form the inductor 20a. As an alternative, it is conceivable that a first coil and a third coil and/or a second coil and a third coil are connected in parallel or are not connected. Thereby, it is also conceivable that a third coil is part of another inductor. Moreover, it is conceivable that a third coil comprises an arbitrary other number of windings and/or layers. Furthermore, a third coil might be formed as a solenoid and/or an elliptic coil. Additionally, it is conceivable that a third coil is flipped and/or mirrored relative to a first coil or a second coil, in particular with respect to a plane which is parallel to a main extension plane of a cooktop. Besides, it is also conceivable to refrain from using a third coil, so that an inductor is formed merely by a first coil and a second coil.

The control unit 18a is provided for controlling a cooking process by regulating a heating output of the inductor 20a and/or the inductors 20a, 22a, in particular by activating a power supply (not shown). Consequently, the control unit 18a is provided to operate the first coil 12a, the second coil 14a and the third coil 16a simultaneously. As a result, a uniform thermal distribution in the cooking utensil 26a can be achieved, wherein an effective diameter of the inductor 20a can be increased while keeping a distance between centers of the coils 12a, 14a, 16a constant. As an alternative, it is conceivable to supply coils with different power supplies of a power supply unit. Moreover, at least for the purpose of improving an efficiency of the induction hob 24a, the control unit 18a is provided to merely operate the inductors 20a, 22a which are located at least partly below the cooking utensil 26a.

FIG. 5 shows the inductor 20a and an at least substantially identical further inductor 22a of the inductors 20a, 22a. The further inductor 22a is directly adjacent to the inductor 20a at least when seen in the direction perpendicular and parallel to the main extension plane of the cooktop 10a. The inductor 20a and the further inductor 22a are arranged in such a way that the inductor 20a and the further inductor 22a comprise an equal effective distance to the cooktop 10a, which in particular results in a particularly uniform heat distribution and/or thermal distribution, in particular in the cooking utensil 26a. In the present case, the effective distance to the cooktop 10a is between 3 mm and 15 mm.

Moreover, the inductor 20a and the further inductor 22a are arranged in such a way that the inductor 20a and the further inductor 22a interleave each other. Thereby, a further second coil 15a of the further inductor 22a, which is in particular located between a further first coil 13a of the further inductor 22a and a further third coil 17a of the further inductor 22a and is in particular equal to the second coil 14a, is at least partly located between the first coil 12a and the third coil 16a at least when seen in the direction perpendicular and/or parallel to the main extension plane of the cooktop 10a. Hence, at least one line exists which is perpendicular to the main extension plane of the cooktop 10a and intersects the inductor 20a and the further inductor 22a at least when seen in the direction perpendicular to the cooktop 10a. By overlapping the inductors 20a, 22a a coverage resolution and by that in particular a flexibility of the induction hob 24a can be advantageously improved which leads to a particularly uniform power distribution. In the present case, the inductors 20a, 22a are moreover supplied using the same power supply. As an alternative, it is also conceivable to supply different inductors, in particular directly adjacent inductors, using different power supplies and/or different phases of a power supply by which advantageously magnetic interferences and/or magnetic disturbances can be effectively reduced.

The FIGS. 6 to 10 show further exemplary embodiments of the invention. The description below and the figures are at least substantially limited to the differences between the exemplary embodiments. Regarding components that are designated in the same way, particularly regarding components having identical reference numerals, reference can be made to the figures and/or the description of the other exemplary embodiment, especially of FIGS. 1 to 5. In order to differentiate the exemplary embodiments, the letter a is added after the reference numerals of the exemplary embodiment in FIGS. 1 to 5. In the exemplary embodiments of FIGS. 6 to 10, the letter a is replaced by the letters b to d.

The FIGS. 6 to 8 show one further embodiment of the invention. The letter b is postposed to the reference numbers of the further embodiment of the FIGS. 6 to 8. The further embodiment of the FIGS. 6 to 8 differs from the previous embodiment at least substantially by a construction of inductors 20b, 22b of an induction hob device.

In the present case each inductor 20b, 22b comprises exactly two coils 12b, 13b, 14b, 15b. A first coil 12b, a second coil 14b, a further first coil 13b and a further second coil 15b are at least substantially semicircular at least when seen in a direction perpendicular to a main extension plane of a cooktop 10b. Thereby, the first coil 12b and the second coil 14b are distanced from each other at least when seen in the direction perpendicular to the main extension plane of the cooktop 10b. Hence, the first coil 12b and the second coil 14b do not overlap. Moreover, the further first coil 13b and the further second coil 15b are distanced from each other at least when seen in the direction perpendicular to the main extension plane of the cooktop 10b. Hence, the further first coil 13b and the further second coil 15b do not overlap.

Thereby, the inductor 20b and the further inductor 22b are mirror-symmetrically, in particular with respect to a plane which is perpendicular to the main extension plane of the cooktop 10b.

As it can be seen from FIG. 8, the inductor 20b and the further inductor 22b comprise an at least substantially interdigitated shape.

FIG. 9 shows one further embodiment of the invention. The letter c is postposed to the reference numbers of the further embodiment of FIG. 9. The further embodiment of FIG. 9 differs from the previous embodiments at least substantially by a construction of inductors 20c, 22c of an induction hob device.

In the present case each inductor 20c, 22c comprises exactly two coils 12c, 13c, 14c, 15c. A first coil 12c and a further second coil 15c are at least substantially identical. Thereby, the first coil 12c and the further second coil 15c are at least substantially circular at least when seen in a direction perpendicular to a main extension plane of a cooktop 10c. Moreover, a second coil 14c and a further first coil 13c are at least substantially identical. The second coil 14c and the further first coil 13c are at least substantially semicircular at least when seen in a direction perpendicular to a main extension plane of a cooktop 10c.

In addition, the second coil 14c is arranged in such a way that the first coil 12c completely covers the second coil 14c at least when seen in the direction perpendicular to the main extension plane of the cooktop 10c. Moreover, the further second coil 15c is arranged in such a way that the further first coil 13c at least partly covers the further second coil 15c at least when seen in the direction perpendicular to the main extension plane of the cooktop 10c.

Thereby, the inductor 20c and the further inductor 22c are rotationally symmetric, in particular with respect to a plane which is parallel to the main extension plane of the cooktop 10c.

The first coil 12c and the further second coil 15c thereby at least partly overlap at least when seen in the direction perpendicular to the main extension plane of the cooktop 10c. In the present case, an overlapping area between the first coil 12c and the further second coil 15c amounts to about 30% of a total surface area of the first coil 12c or the further second coil 15c at least when seen in the direction perpendicular to the main extension plane of the cooktop 10c.

FIG. 10 shows one further embodiment of the invention. The letter d is postposed to the reference numbers of the further embodiment of FIG. 10. The further embodiment of FIG. 10 differs from the previous embodiments at least substantially by a construction of inductors 20d, 22d of an induction hob device.

In the present case, the inductors 20d, 22d are embodied as vector coils. Thereby, at least a first coil 12d, a second coil 14d, a further first coil 13d and a further second coil 15d are at least partly oval and/or elliptic at least when seen in a direction perpendicular to a main extension plane of a cooktop 10d.

### LIST OF REFERENCE NUMBERS

10 cooktop
12 coil
13 coil
14 coil
15 coil
16 coil
17 coil
18 control unit
20 inductor
22 inductor
24 induction hob
26 cooking utensil
28 operating interface

1-14. (canceled)

15. An induction hob device, comprising:
a cooktop;
first and second coils displaced relative to each other at least in a direction perpendicular to the cooktop; and
a control unit configured to at least temporarily operate the first and second coils simultaneously.

16. The induction hob device of claim 15, wherein the first and second coils are substantially displaced relative to each other at least in a direction parallel to the cooktop.

17. The induction hob device of claim 15, wherein the first and second coils at least partly overlap each other at least in a direction perpendicular to the cooktop.

18. The induction hob device of claim 15, wherein the first and second coils are located directly adjacent relative to each other.

19. The induction hob device of claim 15, wherein the first and second coils are electrically connected.

20. The induction hob device of claim 15, further comprising a third coil which is displaced relative to the first and second coils at least in a direction perpendicular to the cooktop, said control unit being configured to at least temporarily operate the third coil simultaneously with the first and second coils.

21. The induction hob device of claim 20, wherein the third coil is substantially displaced relative to at least one of the first and second coils at least in a direction parallel to the cooktop.

22. The induction hob device of claim 20, wherein the third coil and at least one of the first and second coils at least partly overlap each other at least in a direction perpendicular to the cooktop.

23. The induction hob device of claim 20, wherein the third coil and at least one of the first and second coils are electrically connected.

24. The induction hob device of claim 15, wherein the first and second coils at least partly form an inductor.

25. The induction hob device of claim 24, further comprising a further inductor which is substantially identical to the inductor, wherein the inductor and the further inductor comprise an at least substantially equal effective distance to the cooktop.

26. The induction hob device of claim 24, wherein the inductor and the further inductor interleave each other.

27. An induction hob, comprising an induction hob device, said induction hob device comprising a cooktop, first and second coils displaced relative to each other at least in a direction perpendicular to the cooktop, and a control unit configured to at least temporarily operate the first and second coils simultaneously.

28. A method for operating an induction hob device, comprising:
arranging first and second coils offset to each other at least in a direction perpendicular to a cooktop; and
at least temporarily operating the first coil and second coils simultaneously.

29. The method of claim 28, further comprising arranging the first and second coils substantially offset relative to each other at least in a direction parallel to the cooktop.

30. The method of claim 28, further comprising at least partly overlapping the first and second coils at least in a direction perpendicular to the cooktop.

31. The method of claim 28, further comprising arranging the first and second coils directly adjacent relative to each other.

32. The method of claim 28, further comprising electrically connecting the first and second coils.

33. The method of claim 28, further comprising
arranging a third coil in offset relation to the first and second coils at least in a direction perpendicular to the cooktop; and
at least temporarily operating the third coil simultaneously with the first and second coils.

34. The method of claim 33, further comprising arranging the third coil in substantially offset relation to at least one of the first and second coils at least in a direction parallel to the cooktop.

35. The method of claim 33, further comprising at least partly overlapping the third coil and at least one of the first and second coils at least in a direction perpendicular to the cooktop.

36. The method of claim 33, further comprising electrically connecting the third coil and at least one of the first and second coils.

37. The method of claim 28, further comprising connecting the first and second coils to at least partly form an inductor.

38. The method of claim 37, further comprising arranging a further inductor which is substantially identical to the inductor at an at least substantially equal effective distance to the cooktop.

39. The method of claim 37, further comprising interleaving the inductor and the further inductor with each other.
